(19) United States
(12) Patent Application Publication
(10) Pub. No.: US 2009/0251557 A1
(43) Pub. Date: Oct. 8, 2009

(54) IMAGE PICKUP CONTROL METHOD AND APPARATUS FOR CAMERA

(75) Inventors: Ki Tae KIM, Gumi-si (KR); Dong Young CHOI, Gumi-si (KR); Eun Young JUNG, Daegu Metropolitan City (KR); Jae Gon SON, Daegu Metropolitan City (KR); Hong Seok KWON, Daegu Metropolitan City (KR)

Correspondence Address: Jefferson IP Law, LLP, 1130 Connecticut Ave., NW, Suite 420, Washington, DC, 20036, US

(73) Assignee: Samsung Electronics Co. Ltd., Suwon-si (KR)

(21) Appl. No.: 12/407,469

(22) Filed: Mar. 19, 2009

(30) Foreign Application Priority Data
Apr. 8, 2008 (KR) 10-2008-0032756

(51) Int. Cl. H04N 5/225

(52) U.S. Cl. 348/222.1; 348/E05.024

(57) ABSTRACT

An image pickup control apparatus and method for controlling an image pickup device to capture an image of a scene in a condition set by a user are provided. The image pickup control method activates an image pickup unit, sets reference parameters to be compared with current parameters obtained from a preview image input through the image pickup unit for determining whether the preview image satisfies conditions defined by the reference parameters, determines whether a similarity between the current parameters and the reference parameters is within a tolerance range and controls the image pickup unit to capture the image when the similarity is within the tolerance range. Accordingly, a user is able to set the conditions under which an image is to be captured.

### PRIORITY

This application claims the benefit under 35 U.S.C. §119(a) of a Korea patent application filed in the Korean Intellectual Property Office on Apr. 8, 2008 and assigned Serial No. 10-2008-0032756, the entire disclosure of which is hereby incorporated by reference.

### BACKGROUND OF THE INVENTION

1. Field of the Invention

The present invention relates to an image pickup device. More particularly, the present invention relates to an apparatus and method for controlling an image pickup device to capture an image of a scene.

2. Description of the Related Art

An image pickup device is a device for taking an optical image projected on a lens. When using an image pickup device, users want to capture an image of an object having their favorite expressions or in favorable conditions. According to research, although people have different favorite expressions depending on their personal tastes or propensities, their favorite expressions have some conditions and factors in common. In an exemplary case of facial image, most people prefer a smiling face to a gloomy face. That is, it is preferred that a scene to be taken as an image has an attractive expression or condition and that it is not posed or obviously taken for a special purpose. In the case of an object whose condition varies with time however, it is not easy to capture an image of the object in good condition. Accordingly, there is a need for an image pickup technique that enables an image pickup device to capture the image of a scene or an object in a favorable condition as determined by the user.

### SUMMARY OF THE INVENTION

An aspect of the present invention is to address at least the above-mentioned problems and/or disadvantages and to provide at least the advantages described below. Accordingly, an aspect of the present invention is to provide an image pickup control method and apparatus for an image pickup device that is capable of capturing an image of an object in a condition as determined by a user.

In accordance with an aspect of the present invention, an image pickup control method is provided. The method includes activating an image pickup unit, setting reference parameters to be compared with current parameters obtained from a preview image input through the image pickup unit for determining whether the preview image satisfies a conditions defined by the reference parameters, determining whether a similarity between the current parameters and the reference parameters is in a tolerance range and controlling, when the similarity is in the tolerance range, the image pickup unit to capture the image.

In accordance with another aspect of the present invention, an image pickup control apparatus is provided. The apparatus includes an image pickup unit for capturing an image of a scene, an input unit for generating signals input for operating the image pickup unit and a control unit for setting reference parameters in response to the signal input through the input unit, for determining a similarity between current parameters obtained from a preview image input through the image pickup unit in a tolerant range, and for capturing, when the similarity is in the tolerant range, the image of the scene.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description in conjunction with the accompanying drawings, in which:

FIG. 1 is a block diagram illustrating a configuration of a mobile terminal equipped with an image pickup control apparatus according to an exemplary embodiment of the present invention;

FIG. 2 is a block diagram illustrating an exemplary internal structure of the storage unit and the control unit of FIG. 1;

FIG. 3 is a diagram illustrating a process of configuring an image pickup function of a mobile terminal according to an exemplary embodiment of the present invention;

FIG. 4 is a diagram illustrating a process of extracting feature parameters from a preview image in an image pickup control method according to an exemplary embodiment of the present invention;

FIG. 5 is a diagram illustrating an exemplary process of adjusting sensitivity in a conditional capture mode of the mobile terminal of FIG. 1; and

FIG. 6 is a flowchart illustrating an image pickup control method according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Certain terminologies are used in the following description for convenience and reference only and are not limiting. In the following detailed description, only exemplary embodiments of the invention have been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature and not restrictive.

It is to be understood that the singular forms “a,” “an,” and “the” include plural referents unless the context clearly dictates otherwise. Thus, for example, reference to “a component surface” includes reference to one or more of such surfaces.

In the following description, the image pickup control method and apparatus according to an exemplary embodiment of the present invention is described by referring to a mobile terminal equipped with an image pickup device which uses an image evaluation algorithm and indication and condition parameters. In more detail, the image evaluation algorithm includes an algorithm for recognizing an object from a preview image and evaluating the condition of the object by comparing parameters representing feature points of the preview image with reference parameters of an averaged object corresponding to the recognized object. In an exemplary case that the object is a human face and the reference parameters represent the feature points of an average human face, the image evaluation algorithm analyzes a preview image input by the image pickup device to recognize the human face with reference to the reference parameters. In an exemplary implementation, when the object is determined to be a human face, the image evaluation algorithm obtains a black and white image by filtering the preview image and extracts a pattern composed of features, i.e. eyes, nose, and mouth. With the recognition of the facial pattern, the image evaluation algorithm detects a facial profile through a boundary detection process. Next, the image evaluation algorithm performs a fine image evaluation to the feature points such as eyes, nose, and mouth and determines whether the preview image satisfies the conditions set by the user with reference to reference parameters. Here, the preview image can be a preview image displayed on a display unit of the mobile terminal. The values of the facial feature parameters representing the eyes, nose, and mouth in a face vary when the facial expression changes, e.g. from the expressionless face to a smiley face. The parameters of which values can be used for determining a facial expression may include other facial features as well as eyes, nose, and mouth.

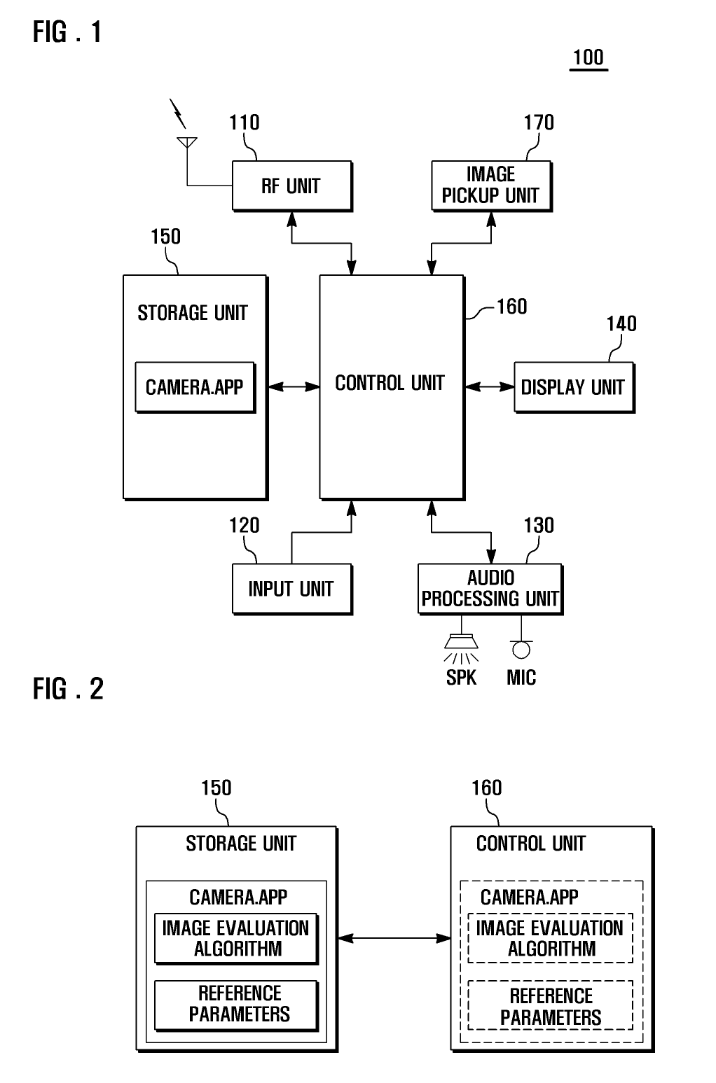

FIG. 1 is a block diagram illustrating a configuration of a mobile terminal equipped with an image pickup control apparatus according to an exemplary embodiment of the present invention. FIG. 2 is a block diagram illustrating an exemplary internal structure of the storage unit and the control unit of FIG. 1.

Referring to FIG. 1, the mobile terminal 100 includes a Radio Frequency (RF) unit 110, an input unit 120, an audio processing unit 130, a display unit 140, a storage unit 150, a control unit 160, and an image pickup unit 170. Although depicted with a focus on the communication and image pickup functions, the mobile terminal can be configured other internal components such as multimedia unit for playing MP3 files, a broadcast reception unit for playing broadcast program contents, a Global Positioning System (GPS) unit and the like. The image pickup unit 170 can be controlled independently of the RF unit 110 and audio processing unit 130.

The mobile terminal 100 stores the image evaluation algorithm and feature parameters for setting the image pickup unit 170 with reference feature parameters within the storage unit 150 and loads the image evaluation algorithm and reference feature parameters on the control unit 160 according to the user input. The control unit 160 executes the image evaluation algorithm set with the reference feature parameters to evaluate a preview image input by the image pickup unit 170. The control unit 160 also controls such that the image pickup unit 170 captures an image having feature parameters consistent with the reference feature parameters, automatically. The structures of the mobile terminal 100 are described hereinafter in more detail.

The RF unit 110 is responsible for establishing a radio channel for voice and video communication of the mobile terminal 100 under the control of the control unit 160. The RF unit 110 can establish a communication channel for transmitting the image obtained by means of the image pickup unit to another terminal or a specific server. The RF unit 110 can be configured to establish a communication channel with an external server or a device for downloading information required for updating the image evaluation algorithm and feature parameters and upgrading firmware of the mobile terminal under the control of the control unit 160.

The input unit 120 is provided with a plurality of alphanumeric keys for inputting alphanumeric data and a plurality of function keys for configuring and executing functions provided by the mobile terminal 100. The functions keys may include navigation keys, side keys, shortcut keys and the like. In an exemplary embodiment, the input unit 120 is provided with function keys for inputting control signals for controlling the image pickup unit 170. In more detail, the input unit 120 is provided with a power key for switching on and off the mobile terminal 100, a menu key for loading function menus including the menu item for activating and deactivating the image pickup unit 170, a mode selection key for selecting a conditional capture mode, a save key for saving an image captured in the conditional capture mode, and the like. The input unit 120 is also provided with hot keys which may be configured to activate the image pickup unit 170 and set the conditional capture mode immediately.

The audio processing unit 130 processes audio data received from the control unit 160 and outputs the processed audio signal through a speaker (SPK). The audio processing unit 130 also processes an audio signal input through a microphone (MIC) and outputs the processed audio data to the control unit 160. In an exemplary embodiment, the audio processing unit 130 is configured to output alarm sounds for notifying of the operation status of the image pickup unit 170. For example, the audio processing unit 130 can be configured such that different alarm sounds notify the start and end of the image capture mode and failure to capture an image after a certain time.

The display unit 140 displays various menus and user input data and operation status information. For example, the display unit 140 may display an idle mode screen, various menu screens, application specific screens including message composition screen and communication progress screen, and the like.

In an exemplary embodiment, the display unit 140 displays an image pickup function screen for allowing a user to activate the image pickup function, activating the conditional capture mode, adjusting sensitivity of capture condition, displaying a preview image, isolating feature points of the object recognized in the preview image, storing the captured image and the like. The interface of the display unit 140 is described in more detail later.

The storage unit 150 stores application programs associated with the function of the mobile terminal 100 including an image pickup application operating with association with the image pickup unit 170 (e.g. camera.App.) and images captured by the image pickup unit 170. The storage unit 150 may work as a buffer for temporarily storing the preview images during a preview process. The storage unit 150 may be divided into a program region and a data region. The image pickup application (camera.App) may include the image evaluation algorithm and reference feature parameters (see FIG. 2).

The program region stores an Operating System (OS) for booting up the mobile terminal 100 and providing an interface between hardware and the application programs. The program region also stores application programs including communication protocols for enabling the communication of the mobile terminal 100 and multimedia programs for playing audio and still and motion images. The mobile terminal 100 executes its functions in association with the corresponding application under the control of the control unit 160. In an exemplary embodiment, the image pickup application (camera.App) provides a preview function, a conditional capturing function, a reference parameter adjustment function, an auto and manual image saving functions, and the like. The image pickup application (camera.App) is provided with the image evaluation algorithm for evaluating the conditions of a preview image and adjusting the reference feature parameters while viewing the preview image. The reference parameters and the image evaluation algorithm can be stored within the program region as the factors designated for the camera.App according to the intention of a program designer.

The application region stores data generated during the operation of the mobile terminal 100, and the data may include still and motion images captured by the image pickup unit 170. The data region stores user data associated with various optional functions such as a phonebook, audio and video contents, user information and the like. In an exemplary embodiment, the data region stores the image evaluation algorithm and reference feature parameters for supporting the conditional capture mode of the camera.App. That is, the data region can be configured to store the image evaluation algorithm for evaluating the preview images input by the image pickup unit 170 and the reference feature parameters for use with the image evaluation algorithm.

The image pickup unit 170 converts analog data of the captured image to digital data and outputs the digital data to the control unit 160. The digital data obtained by means of the image pickup unit 170 may be stored according to the user's selection. The image pickup unit 170 may send the image data to the display unit 150 so as to be displayed as a preview image. When operating in the conditional capture mode, the image pickup unit 170 evaluates the preview image and determines whether the preview image satisfies a preset condition under the control of the control unit. 160. If the preview image satisfies the preset condition, then the image pickup unit 170 captures the image under the control of the control unit 160. The captured image may be stored automatically or manually according to the user setting. The operation of the image pickup unit 170 is described in more detail with the explanation of the interface of the display unit 150 later.

The control unit 160 controls signaling among the internal components and generates control signals for executing operations of the mobile terminal. When the mobile terminal powers up, the control unit 160 controls such that the mobile terminal 100 boots up and outputs a preset idle mode screen image onto the display unit 140. In the idle mode, the control unit 160 controls such that a menu screen is output in response to a user command and an image pickup application screen is output in response to an image pickup function activation command. In a case that the conditional capture mode is activated, the control unit 160 re-configures the camera.APP to execute the conditional capture mode such that the incident optical signal input through a lens is converted to be output in the form of a preview image. Next, the control unit 160 executes the image evaluation algorithm such that the image evaluation algorithm evaluates whether the feature parameters of the preview image is in consistency with the reference feature parameters. If the feature parameters of the preview image are consistent with the reference features, then the control unit 160 captures the image. The control unit 160 can control such that a reference feature parameter adjustment screen is presented for the user to adjust the reference parameters while the image pickup unit 170 operates in the conditional capture mode. The reference feature parameter adjustment screen is described in more detail later with the explanation on the screen interface.

As described above, an exemplary mobile terminal 100 is configured for the user to adjust the values of the reference feature parameters in the conditional capture mode, whereby the user can configure the image pickup unit to capture an image satisfying the user's favorite condition.

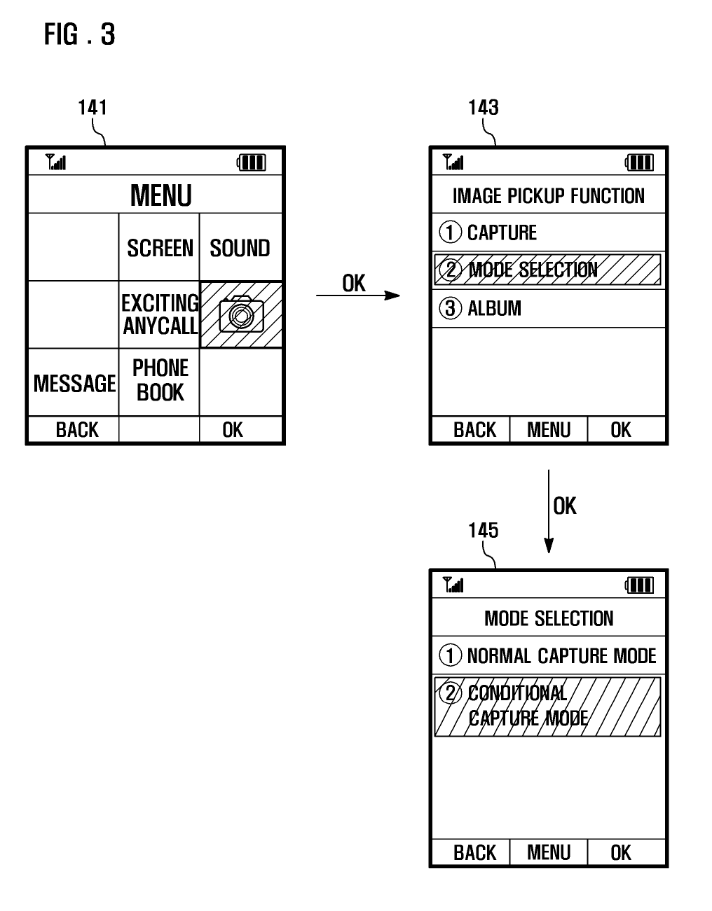

FIG. 3 is a diagram illustrating a process of configuring an image pickup function of a mobile terminal according to an exemplary embodiment of the present invention.

Referring to FIG. 3, if a menu request command is input through the input unit 120, then the control unit 160 controls such that a main menu screen 141 is displayed on the display unit 140. The main menu screen 141 includes various menu items such as “display,” “sound,” “exiting anycall,” “message,” “phonebook,” and “contents box” presented in the forms of texts or icons. The main menu screen 141 is also provided with a “back” button for returning to the idle mode screen and an “OK” button for selecting the menu item highlighted by a cursor. The user can navigate the cursor across the menu items by manipulating navigation keys. If a navigation key input is detected, then the control unit 160 controls such that the cursor moves in a direction corresponding to the navigation key input and the menu item on which the cursor moves is highlighted. If the “OK” button is selected while the cursor is placed on a camera menu item in the main menu screen 141, then the control unit 160 controls such that an image pickup menu screen 143 is displayed on the display unit 140.

The image pickup menu screen 143 includes setting menus. In the illustrated example, the image pickup menu screen 143 includes a “capture” menu, a “mode selection” menu, and an “album” menu. If the capture menu is selected, then the control unit 160 activates the image pickup unit 170 immediately. If the album menu is selected, then the control unit 160 controls such that the previously stored photos are presented in the forms of full screen images or tiled thumbnail images. The image pickup menu screen 143 also includes a “back” button for returning to the previous screen, a “menu” button for returning to the main menu screen 141, and an “OK” button for selecting a menu item at the bottom. The user can navigate the cursor across the menu items by manipulation of the navigation keys. If the “OK” button is selected while the cursor is placed on a menu item, then the control unit 160 controls such that the function associated with the menu item is executed. Although the image pickup menu screen 143 is depicted with three menu items in FIG. 3, other menu items (such as “transmission” menu for transmitting captured image to an external server or another mobile terminal) can be added to the image pickup menu screen 143.

If the “mode selection” menu is selected from the image pickup menu screen 143, the control unit 160 controls such that a mode selection screen 145 is displayed on the display unit 140. In the example illustrated in FIG. 3, the mode selection screen includes a “normal capture mode” menu and a “conditional capture mode” menu. In the normal capture mode, the user captures an image manually by pushing a shutter button. Otherwise, when the conditional capture mode is activated, the control unit controls such that the image pickup unit 170 captures an image having feature parameters that satisfy the conditions of the reference feature parameters set for the conditional capture mode. The conditional capture mode can be called various names such as “smile mode” or “non-blink mode” depending on the conditions to be applied. The mode selection screen 145 also includes the “back” button, “menu” button, and the “OK” button similar to the image pickup menu screen.

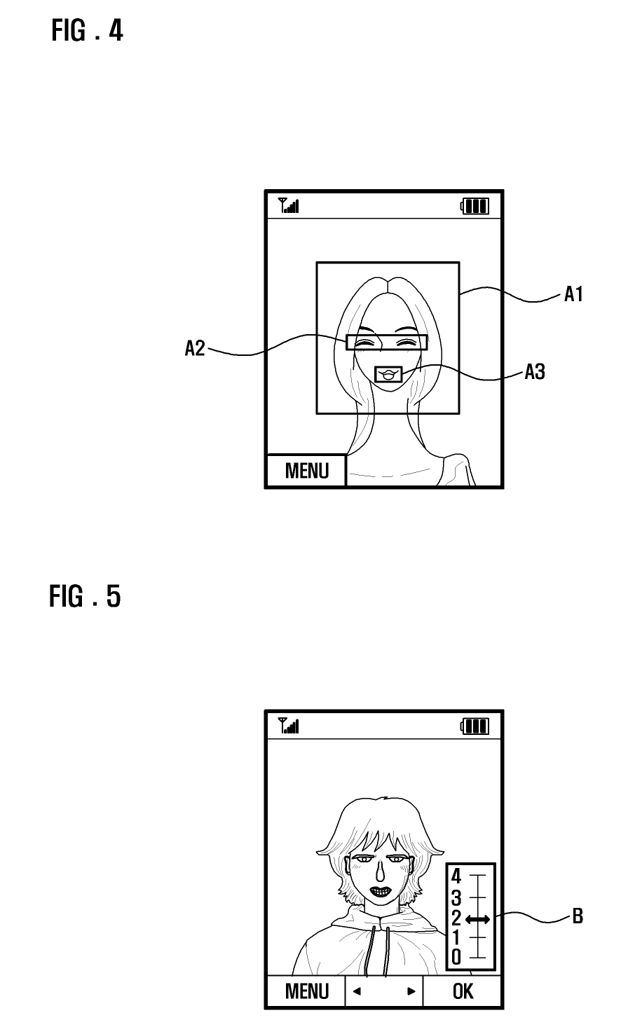

FIG. 4 is a diagram illustrating a process of extracting feature parameters from a preview image in the image pickup control method according to an exemplary embodiment of the present invention.

Referring to FIG. 4, the image pickup unit 170 pre-captures a preview image and isolates feature areas in the preview image under the control of the control unit 160. That is, the control unit 160 filters an optical image input through a lens of the image pickup unit 170 and isolates feature points, e.g. eyes, nose, mouth, ears, and cheekbone areas to recognize a human face. In order to recognize the human face and facial expression, the image evaluation algorithm may be provided with sample data of facial features so as to recognize a human face by comparing image data of the preview image with the reference data sample. In an exemplary implementation, the control unit 160 extracts a boundary of a face using the reference data sample on the relationship between two eyes and mouth that are typically observed in the human face. The control unit 160 informs the user of the facial recognition status using brackets. The brackets are used to isolate the facial features such as the facial profile, eyes, and mouth in contrast to the background and the rest of the image and can be replaced with various marking symbols.

The control unit 160 also collects image data on the facial features (i.e. the eyes, mouth, and cheekbone areas from the facial image captured by the image pickup unit 170) that correspond to the reference feature parameters and determines the shapes of the facial features on the basis of the data. The control unit 160 determines whether the parameters extracted from the data on the eyes, mouth, and cheekbone area regions match with the reference feature parameters. If the feature parameters of the facial image match with the reference feature parameters, then the control unit 160 controls such that the image pickup unit 170 captures the preview image. For this purpose, the control unit 160 is configured to recognize the facial profile and feature points including eyes, mouth, cheekbone areas, nose, and eyes from the image preview by the image pickup unit 170, simultaneously or individually one by one. That is, the control unit 160 first extracts a facial profile from the image data input through the image pickup unit 170 and controls such that the preview image is displayed on the display unit 140 together with a rectangular face indication box A1 drawn around the facial profile. Next, the control unit 160 extracts eyes, mouth, and cheekbone area regions corresponding to the reference feature parameters within the face indication box A1. These regions, i.e. the eyes and mouth regions, are displayed with an eyes indication box A2 and a mouth indication box A3 on the display unit 140. Next, the control unit 160 analyzes the similarities between the feature parameters extracted from the eyes indication box A2 and the mouth indication box A3 and the corresponding reference feature parameters. These indication boxes A1, A2, and A3 may move on the preview image as the eyes and mouth regions move according to the change of the preview image. In order to compare the currently extracted feature parameters and the reference feature parameter, the control unit 160 stores the parameter values. At this time, each facial feature can be represented by a plurality of feature parameters in consideration of the expression diversity. For example, the feature of an eye can be determined with multiple parameters such as a slope angle and an opening width of the eye. In the case of a mouth, the feature can be determined with angles of lips, opening contour, tooth appearance, and the like. Also, the feature of cheekbone areas can be determined with shapes of valleys formed between the nose and the cheekbone areas, i.e. the depth and width of shadows formed between the nose and the cheekbone areas. The values of the reference parameters can be obtained through experiments or input from an external source. The control unit 160 can set the feature parameters with different values according to conditions in the conditional capture mode. For example, when the mobile terminal is operating in the conditional capture mode, i.e. a smiling face capture mode, the control unit 160 can adjust a smile sensitivity of the conditional capture mode by resetting the feature parameters corresponding to an average of acquired smiling faces according to user input. The sensitivity adjustment procedure is described in more detail with reference to FIG. 5.

FIG. 5 is a diagram illustrating an exemplary process of adjusting sensitivity in a conditional capture mode of the mobile terminal of FIG. 1.

Referring to FIG. 5, the control unit 160 controls such that a meter (B) which allows a user to adjust the sensitivity of the conditional capture mode is displayed in the preview screen. The control unit 160 adjusts the sensitivity of the conditional capture mode, according to input signals received through navigation keys of the input unit 120, to be consistent with the up and down of the indication needle of the meter (B). In more detail, a condition sensitivity meter (B) having sensitivity levels (i.e. level 0 to level 4) and including an indication needle, is displayed at one side of the preview screen, whereby the user can adjust the condition sensitivity level while viewing the movement of the indication needle. According to the change of the condition sensitivity, the values of the reference parameters are changed. In an exemplary case of a smiling capture mode, when the condition sensitivity is set to level 0, the control unit 160 determines a smiling face with great sensitivity. Accordingly, the control unit 160 regards a facial expression with very small lip angles and narrow opening of the mouth as an expression of a smile. At level 1, the control unit regards a facial expression having the lip angle and mouth opening a little greater than those of the level 0. At level 2, the control unit 160 regards a facial expression having the lip angle and mouth opening a little greater than those of the level 1. At level 3, the control unit 160 regards a facial expression having the lip angle and mouth opening a greater than those of the level 2. At level 4, the control unit 160 regards the facial expression having a lip angle and mouth opening significantly greater than those of other levels. Although the smiling face is determined with reference to the change of the lip angle and opening width of mouth in this exemplary case, other feature parameters (such as the shape of side edge, variation of mouth shape, opening shape of the mouth) can be used for determining the smiling face. Once the sensitivity level is determined, the control unit 160 controls such that, when the preview image satisfies the conditions represented by the parameter values at the sensitivity level, the image picture unit 170 captures the image having the at the time point when the conditions are satisfied. The conditional capture mode can be configured with more reference feature parameters associated with eyes, nose, nostrils, cheekbone areas, chin line and the like. These parameters can be averaged through experiments and applied to the sensitivity meter (B) for adjusting the condition sensitivity of the image pickup unit 170.

The sensitivity meter (B) can be provided in the form of a unified meter, a set of individual meters, and the like. In this case, the control unit 160 can be configured such that the image pickup menu screen 143 includes a sensitivity option menu which, when selected, shows a list of the meters. The unified meter is configured to adjust all the reference parameters corresponding to the eyes, nose, mouth, and cheekbone areas at a time, consistently. For example, when the eye, nose, mouth, and cheekbone areas are featured with 5 reference parameter values, respectively, the unified meter changes the values of the reference parameters corresponding to the eye, nose, mouth, and cheekbone areas at a time. The individual meters may include an eye sensitivity meter, a nose sensitivity meter, a mouth sensitivity meter, and cheekbone area sensitivity meter that can allow the user to adjust the sensitivities to the respective feature points, individually. Although the individual sensitivity adjustment is described with four individual meters that correspond to eye, nose, mouth, and cheekbone areas, more individual meters, for example for adjusting sensitivity at other facial features such glabella, philtrum, brow, neck, and chin angle, may be provided.

As described above, the control unit 160 controls the image pickup unit 170 to be set with the reference feature parameter interactively in response to the user input in the conditional capture mode, whereby the user can adjust the values of the reference feature parameter to effectively capture an image in an intended condition in consideration of different profiles of people. Also, the user can reduce the malfunctioning possibility of the conditional capture mode by decreasing the condition sensitivity. To decrease the condition sensitivity means that the control unit 160 changes the reference feature parameters such as angle of eye line so as to evaluate the smiling face with more discrimination. The adjustment of the condition sensitivity may be performed by changing the values of other reference feature parameters such as angle of mouth line, shape of mouth opening, depth of shadow cast by the cheekbone areas. By dulling the condition sensitivity, the possibility to capture an image with a non-smiling face decreases. This condition sensitivity adjustment can be performed by the user to move the indication needle along the sensitivity levels 0 to 4 of the sensitivity meter displayed in the preview screen.

Until now, the structures of a mobile terminal equipped with image pickup control apparatus, reference feature parameters set with the image pickup unit, and screens associated with the conditional capture mode according to an exemplary embodiment of the present invention have been described. The image pickup control method is described hereinafter in association with the above structured mobile terminal.

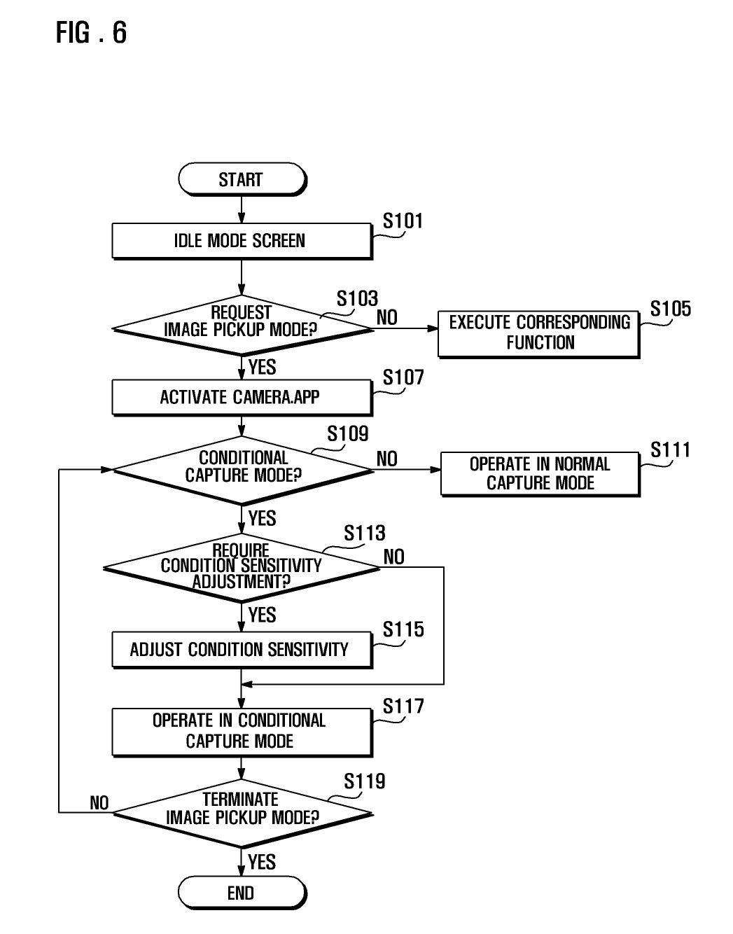

FIG. 6 is a flowchart illustrating an image pickup control method according to an exemplary embodiment of the present invention.

Referring to FIG. 6, once the mobile terminal powers up, the control unit 160 boots up the mobile terminal and controls such that a preset idle mode screen is displayed on the display unit 140 in step S101.

In the idle mode, the control unit 160 detects a signal input through input unit 120 and determines whether the input signal is an image pickup mode request command in step S103. That is, if a user input signal is detected in the idle mode, then the control unit 160 determines whether the user input signal is the image pickup mode activation command.

If the user input signal is not the image pickup mode activation command, then the control unit 160 executes a command corresponding to the user input signal in step S105. The command can be for requesting activation of a voice communication function, a video communication function, a data transmission function, a file playback function, an Internet access function, a search function and the like.

If the user input signal is the image pickup mode activation command, then the control unit 160 loads the image pickup application program, e.g. camera.APP such that the mobile terminal enters the image pickup mode in step S107. The camera.APP is an application program providing various functions required for operating the image pickup unit 170, particularly the functions associated with the normal capture mode and the conditional capture mode of the image pickup unit 170. These functions include a preview image display function, an image evaluation algorithm provision function, and libraries that provide reference parameters required for evaluating the image.

Next, the control unit 160 determines whether the image pickup unit 170 is set to the conditional capture mode in step S109. That is, the control unit 160 controls to display the image pickup menu screen and determines whether the conditional capture mode option is selected in the image pickup menu screen.

If the image pickup unit 160 is not set to the conditional capture mode but to the normal capture mode, then the control unit 160 controls such that the image pickup unit 170 operates in the normal capture mode in step S111. Here, the normal capture mode is an operation mode in which the image pickup unit 170 captures the image displayed in the preview screen in response to the push of a shutter key or a shutter button. The control unit 160 supports various camera functions (such as zoom-in function, zoom-out function, filtering function, panorama functions, auto-focusing function and the like) in the normal capture mode.

Otherwise, if the image pickup unit 170 is set to the conditional capture mode, then the control unit 160 determines whether a sensitivity adjustment is required in step S1 13. Here, the sensitivity adjustment step can be provided as a default step when the conditional capture mode selected at step S109 or in response to selection of a specific menu item. That is, when the conditional capture mode is activated at step S109, the control unit 160 may control such that a popup window asking whether to adjust the sensitivities of the reference parameters is displayed. At this time, the control unit 160 controls such that the sensitivity adjustment menu item is provided.

If the sensitivity adjustment is required at step S113, the control unit 160 controls such that a condition sensitivity adjustment screen is displayed for allowing the user to adjust the sensitivity in step S115. As aforementioned, when the feature parameters corresponding to the eyes, nose, mouth, ears, brow, glabella, philtrum, chin, head, cheekbone areas and the like, are set for facial recognition, the control unit 160 controls such that the condition sensitivity adjustment screen, composed of a unified meter for adjusting the reference feature parameters at one time or a set of individual meters for adjusting the individual reference feature parameters, is displayed. In response to the instructions input through the condition sensitivity adjustment screen, the control unit 160 adjusts the condition sensitivity. Since the structures and functions of the unified meter and individual meters are described with reference to FIG. 5 above, the descriptions of the unified and individual meters are omitted here.

After completing the adjustment of the condition sensitivity, the control unit 160 controls such that the image pickup unit 170 operates with the adjusted condition sensitivity in the conditional capture mode in step S117. Here, the control unit 160 activates the image evaluation algorithm set with the reference feature parameters and determines whether the feature parameters extracted from a preview image match with the reference feature parameters. At this time, the control unit 160 first performs a facial recognition to outline a face on the preview image and then feature point recognition for locating feature points (e.g., eyes, nose, mouse, and the like) in the recognized face. The control unit 160 determines the similarity of the feature parameters obtained from the preview image to the reference feature parameters. If the similarity is within a tolerance range, the control unit 160 controls such that the image pickup unit 170 captures the image. The control unit 160 can be configured to support the auto-focusing functions. In order to tolerate the mechanical offset and programmable offset in a range, when the similarity between the current feature parameters and the reference feature parameters is within the tolerance range, it may be determined that the current feature parameters and the reference feature parameters are identical with each other.

While the image pickup unit 170 operates in the conditional capture mode, the control unit 160 determines whether an image pickup mode termination command is detected in step S119. If no image pickup mode termination command is detected, then the control unit 160 returns to step S109. Otherwise, if an image pickup mode termination command is detected, then the control unit 160 ends the image pickup mode.

As described above, an exemplary image pickup control method of the present invention supports a conditional capture mode in which an image pickup unit recognizes a specific expression defined with feature parameters extracted from a preview image and captures the image satisfying conditions of the feature parameters automatically. In an exemplary implementation, the image pickup control method of the present invention enables the user to adjust values of the reference feature parameters which determine the condition sensitivity to capture the image, thereby effectively capturing an image in a favorite condition in consideration of a variety of target objects.

Also, an exemplary image pickup control method and apparatus of the present invention enables an image pickup device to capture an image of an object in an optimized condition configured by the user.

Although exemplary embodiments of the present invention are described in detail hereinabove, it should be clearly understood that many variations and/or modifications of the basic inventive concepts herein taught which may appear to those skilled in the present art will still fall within the spirit and scope of the present invention, as defined in the appended claims and their equivalents.

What is claimed is:

1. An image pickup control method, the method comprising:
activating an image pickup unit;
setting one or more reference parameters for comparison with one or more current parameters obtained from a preview image input through the image pickup unit for determining whether the preview image satisfies a condition defined by the one or more reference parameters;
determining whether a similarity between the one or more current parameters and the one or more reference parameters is within a tolerance range; and
controlling, when the similarity is within the tolerance range, the image pickup unit to capture the image.

2. The method of claim 1, wherein the one or more reference parameters comprise feature parameters indicating states of feature points in a human face.

3. The method of claim 2, wherein the setting of the one or more reference parameters comprises at least one of adjusting the one or more reference parameters in a unified manner and adjusting the one or more reference parameters individually.

4. The method of claim 2, wherein the feature points include at least one of eyes, a nose, a mouth, ears, cheekbone areas, a glabella, a philtrum, and shadow areas between the cheekbone areas and the nose.

5. The method of claim 2, wherein the one or more reference parameters comprise feature points indicating a human face while smiling.

6. The method of claim 5, wherein the feature points correspond to an eye and include at least one of a slope angle and an opening width.

7. The method of claim 5, wherein the feature points correspond to a mouth and include at least one of an angle of lips, an opening contour and a tooth appearance.

8. The method of claim 1, wherein the determining of whether the similarity is within the tolerance range comprises:
recognizing a facial profile from the preview image; and
recognizing feature points corresponding to the one or more reference parameters in the facial profile.

9. The method of claim 8, wherein the recognizing of the facial profile comprises isolating the facial profile.

10. The method of claim 9, wherein the recognizing of the feature points comprises isolating the feature points.

11. The method of claim 1, further comprising saving the captured image automatically.

12. An image pickup control apparatus, the apparatus comprising:
an image pickup unit for capturing an image of a scene;
an input unit for generating signals input for operating the image pickup unit; and
a control unit for setting one or more reference parameters in response to the signal input through the input unit, for determining if a similarity between one or more current parameters obtained from a preview image input through the image pickup unit and the one or more reference parameters is within a tolerance range, and for capturing, when the similarity is within the tolerance range, the image of the scene.

13. The apparatus of claim 12, further comprising:
a storage unit for storing an image evaluation algorithm for evaluating a condition of the image and for storing the one or more reference parameters; and
a display unit for displaying the preview image and a reference parameter setting screen for allowing a user to adjust values of the reference parameters.

14. The apparatus of claim 13, wherein the display unit displays at least one of a face isolation mark isolating a facial profile and feature points isolation marks isolating positions of feature points within the facial profile, on the preview image.

15. The apparatus of claim 13, wherein the control unit controls the captured image to be stored in the storage unit automatically.

16. The apparatus of claim 12, wherein the one or more reference parameters comprise feature points indicating a human face while smiling.

17. The apparatus of claim 16, wherein the feature points comprise at least one of eyes, a nose, a mouth, ears, cheekbone areas, a glabella, a philtrum, and shadow areas between the cheekbone areas and the nose.

18. The apparatus of claim 16, wherein the feature points change in shape according to variation of facial expression.
